(19) United States
(12) Patent Application Publication
(10) Pub. No.: US 2026/0099765 A1
(43) Pub. Date: Apr. 9, 2026

(54) META-DATA CENTRIC APPROACH FOR PREDICTED CLASS REASSIGNMENT

(71) Applicant: HEWLETT PACKARD ENTERPRISE DEVELOPMENT LP, Spring, TX (US)

(72) Inventors: Madhusoodhana Chari Sesha, Bangalore (IN); Pradeep Kumar Surendran, Bangalore (IN); Ankush Anshuman, Bangalore (IN); Akshay Jain, Bangalore (IN); Surya Thankamony Somanathan, Bangalore (IN)

(21) Appl. No.: 18/967,020

(22) Filed: Dec. 3, 2024

(30) Foreign Application Priority Data
Oct. 9, 2024 (IN) 202441076571

(51) Int. Cl. G06N 20/00

(52) U.S. Cl. CPC G06N 20/00

(57) ABSTRACT

Systems and methods are provided for reassigning classifications based on performance metrics obtained from prior instances of classifications. Examples include obtaining performance metrics of instances of classifications performed by a classification model in classifying data samples and generating a confusion matrix for the classification model that clusters the instances of classifications into a plurality of groups. For each group of the plurality of groups, examples derive a threshold from the performance metrics for instances of data samples constituting the respective group. The examples determine whether or not a classification predicted for an input data sample is correct based on a prediction performance metric of the predicted classification and one or more of the thresholds for the plurality of groups of the confusion matrix. Examples can update the predicted classification based on the determination.

### BACKGROUND

Artificial Intelligence (AI) and machine learning (ML) applications are becoming an increasingly important part of enterprise operations, and classification algorithms may be an integral part of these AI applications. Many entities rely on extensive data collection to enhance processes, and it can be challenging to collect and analyze data effectively on this scale. Classification can make this process simpler by automating the process of analysis and classification.

In ML, classification can be implemented automatically assigns (e.g., classifies) data samples to categories or classes. A classifier implements a classification model, which may embody a classification algorithm trained on training data sets to classify input data samples into one or more classes.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 depicts a schematic block diagram of an environment for performing classifying data samples, in accordance with the examples disclosed herein

FIG. 2 illustrates an example confusion matrix that can be utilized in the implementations of the disclosed technology.

FIG. 3 illustrates a simplified example of performance thresholds overlaid on the confusion matrix of FIG. 2.

FIG. 4 illustrates an example process and database connections for classifying input data samples, in accordance with the examples disclosed herein.

FIG. 5 illustrates an example sub-process that may be part of the process of FIG. 4 and database connections for determining performance thresholds, in accordance with the examples disclosed herein.

FIG. 6 illustrates a system in which various of the examples presented herein may be implemented.

FIG. 7 illustrates a schematic block diagram of backend system of the system shown in FIG. 6.

FIG. 8 illustrates an example process flow for classifying data traffic, according to an example implementation of the disclosed technology.

FIG. 9 is an example computing component that may be used to implement various features of classifying data samples in accordance with the implementations disclosed herein.

FIG. 10 is an example of another computing component that may be used to implement various features of classifying data samples in accordance with the implementations disclosed herein

FIG. 11 is a computing component that may be used to implement examples of the disclosed technology.

The figures are not exhaustive and do not limit the present disclosure to the precise form disclosed.

### DETAILED DESCRIPTION

As discussed above, classifiers can implement classification models to classify data samples into one or more classes. However, in some instances, the classification model may predict a data sample belongs to a class when it actually does not (e.g., a first type of misclassification referred to herein as a “false positive misclassification” or “false positive”), or predict that a data sample does not belong to the class when it actually does (e.g., e.g., a first type of misclassification referred to herein as a “false negative misclassification” or “false negative”). Misclassifications of either type can be detrimental, for example, in user adaption and model refinement. For example, a classification model that misclassifies data samples may be less reliable and, as result, users may be less likely to adapt and utilize such a model. Additionally, predictions by a classification model may be used to update training data sets for retrained and refining the classification model. However, if such classifications are incorrect, then the classification model may be trained on improperly labeled data sets.

Against this backdrop, examples disclosed herein provide for techniques for reassigning classifications for input data samples that are predicted (e.g., inferred or otherwise determined) by a classification model based on performance metrics obtained from instances of classifications performed by the classification model. An “instance of classification,” as used herein, refers to an iteration of the classification model predicting or otherwise inferring a class for a data sample. In some examples, an “instance of classification” may also include assigning the data sample to the predicted class by labeling the input data sample with the class. Each data sample can be represented as a set of features (e.g., a feature vector) that the classification model uses to predict a class for each respective data sample. Labelling (or “tagging”), as used herein may include generating metadata comprising a character string of the assigned class, which can be stored with other metadata and associated with a data sample. Performance metrics, according to examples disclosed herein, may refer to a measure of the classification models performance for a given instance of classification. Performance metrics may include, but are not limited to, an accuracy of the classification for a given instance of classification. The accuracy of the classification may obtained in the form of a confidence score that provides a probability that the data sample belongs to the predicted class.

In examples, implementations of the presently disclosed technology may compare a measure of performance for an instance of classifying an input data sample (referred to herein as a “prediction performance metric” or “prediction performance measure”) against performance thresholds of historical instances of classifications. In an illustrative example, a confusion matrix of historical instances of classifications by a classification model may be generated. In some examples, the confusion matrix may be generated based on performance metrics of classification instances obtained while building (e.g., training and/or verifying) the classification model on training data sets or verification data sets. Additionally, in some examples, the confusion matrix may be updated based performance metrics obtained from instance of classifications on input data samples applied to the trained classification model. The confusion matrix may categorize instances of classifications into one of a plurality of groups comprising a true positive group, a false positive group, a true negative group, and a false negative group. Performance thresholds can be obtained for each of the groups based on performance metrics of the instances that constitute a respective group.

Examples herein may predict a class for an input data sample and determine whether or not that predicted class is appropriate (e.g., correct) by comparing the prediction performance metric of the current instance against one or more performance thresholds of one or more of the groups of the confusion matrix. The comparison may include determining whether or not the prediction performance metric satisfies the one or more of the performance thresholds. The predicted classification can then be updated based on the determination. For example, the disclosed technology can confirm that the predicted class is correct and assign the data sample to the predicted class, determine that the predicted class is incorrect and compare the performance of the prediction to performance thresholds of another class, and/or update the performance thresholds of one or more groups based on determining that the predicted class is correct.

In some examples, the performance thresholds may comprise a first performance threshold based on heuristic data extracted during training of the classification model. As used herein, the first performance threshold may be referred to as a heuristic-based threshold. For example, during the training process, performance metrics of the each instances of the training can be extracted. Heuristic data can be determined as a function of the performance metrics constituting a respective group, for example, an average of performance metrics constituting a respective group, a maximum of the performance metrics constituting a respective group, a minimum of performance metrics constituting a respective group, a standard deviation of the performance metrics constituting a respective group, etc. These heuristic data can be used as the heuristic-based threshold to determine if a predicted classification is correct or not. If the prediction performance metric satisfies the heuristic-based threshold, then the input data may be considered as belonging to the predicted class. However, if the prediction performance metric does not satisfy the heuristic-based threshold, then the input data may be considered to not belong to the predicted class.

As an example, a heuristic-based threshold may be an average of performance metrics constituting a group into which the input data is classified. In this case, if the prediction performance metric is less than average, the input data is considered as not belonging to that group. Whereas, if the prediction performance metric is equal to or greater than the average, the input data can be considered as belonging to that group. In some cases, heuristic-based threshold may base on a standard deviation. For example, the heuristic-based threshold may be the average minus the standard deviation. In another example, the first threshold performance may be set as the minimum of performance metrics constituting a respective group.

The performance thresholds may also comprise a second performance threshold that may be based on one or more centroids computed for each respective group of the confusion matrix. The second performance threshold may be referred to as a centroid-based threshold. The centroids may be computed from sets of features of data samples corresponding to instances of classification that constitute a respective group. In examples, the sets of features may be represented vectors and each quadrant of the confusion matrix may be represented as a vector space formed of the sets of features of data samples that make up corresponding to instances of classification that constitute a respective quadrant. For a given quadrant, one or more centroids can be computed from those feature sets corresponding to the quadrant. For example, a first one or more centroids can be computed for the group of true positives from sets of features corresponding to true positive classifications, a second one or more centroids can be computed for the group of false positives from sets of features corresponding to false positive classifications, a third one or more centroids can be computed for the group of true negatives from sets of features corresponding to true negative classifications, and a fourth one or more centroids can be computed for the group of false negatives from sets of features corresponding to false negative classifications.

Centroids can be computed by known techniques. For example, the elbow method may be used to compute one or more centroids from sets of features. In this case, the sets of features corresponding to a given quadrant can be clustered into one or more clusters and a centroid can be computed for each cluster. Thus, the elbow method can be used to provide one or more centroids for each quadrant. Examples herein are not limited to this method and other known techniques for computing centroids can be used.

In an example, the second performance threshold for a respective group may be based on a threshold distance of an input data sample from the one or more centroids of anther group. For example, the classification model may predict a class for an input data sample and this class may correspond to a quadrant (or group) of the confusion matrix. A prediction distance can be determined as a distance from the input data sample to the one or more centroids of the quadrant corresponding to the predicted class. A threshold distance for this quadrant may be determined as a distance from the input data sample to one or more centroids of another quadrant of the confusion matrix. The prediction distance can be compared to the threshold distance and the predicted class can be confirmed based on the comparison. For example, if the prediction distance is less than the threshold distance, the predicted class can be considered correct. Otherwise, the predicted class may need to be reclassified. In this way, the second performance threshold of a given group may be defined as a threshold distance from one or more centroids that an input data sample is expected to lie to satisfy this particular second performance threshold.

In examples, the prediction distance may be determined as a function of a set of feature of the input data sample to the one or more centroids of a quadrant corresponding to the predicted class. For example, the input data sample can be represented as a feature vector (e.g., the set of features). A distance from the set of features to each of the one or more centroids can be derived using the feature vector and each centroid as coordinates (e.g., x and y coordinates in the case of a two dimensional feature vector or a N coordinates in the case of a N dimensional feature vector). In some examples, the prediction distance can be the average of the distances between the input data sample and each centroid. In another example, the prediction distance may be a minimum of the distances. In some examples, a standard deviation across the distances can be accounted for in the distance. The threshold distance may be determined in a similar manner, but with respect to another quadrant.

In some examples, the technology disclosed herein may determine if a prediction performance metric satisfies a heuristic-based threshold prior to evaluating a classification prediction with respect to centroid-based threshold. For example, the examples herein may predict a class for an input data sample and determine a prediction performance metric for the classification. This prediction performance metric can be compared to the heuristic-based threshold. If the prediction performance metric satisfies the heuristic-based threshold, then the classification can be considered correct. Otherwise, the predicted classification can be compared to the centroid-based threshold to determine whether the input data sample should be reclassified or not. For example, a distance to one or more centroids of a group corresponding to the predicted classification from the feature set representing the input data sample used to make the prediction can be computed and compared against the centroid-based threshold.

To determine if the classifier has correctly predicted a classification for an input data sample, some examples herein, compare the instance of classifying the input data sample to one or more of the performance thresholds for a true positive group of the confusion matrix. For example, if the predicted class satisfies the performance thresholds, the predicted classification can be considered a true positive and the input data sample belongs to the class. For example, a predication performance metric of the predicted class can be compared to a heuristic-based threshold. If the prediction performance metrics is equal to or greater than the heuristic-based threshold, then the predicted classification can be considered a true positive. Otherwise, a prediction distance of the input data sample to the true positive group can be compared to a threshold distance of the input data sample to the false negative group (e.g., as an example centroid-based threshold of the true positive group). If the prediction distance is less than the threshold distance, then the predicted classification can be considered a true positive. Accordingly, examples herein may label the input data sample according to the predicted class.

However, if the predicted classification does not satisfy the performance thresholds (e.g., prediction performance metric is less than a heuristic-based threshold and the prediction distance is equal to or greater than the threshold distance for the true positive group), a prediction distance to the false negative group can be compared to a threshold distance of the false negative group. In this case, the centroid-based threshold of the true positive group may become the prediction distance to the false negative group and the threshold distance of the false negative group may be computed using the one or more centroids of the true negative group. If the prediction distance satisfies a threshold distance for the false negative group (e.g., the prediction distance for the false negative group is less than the threshold distance for the false negative group), the predicted class can be considered a false negative. Being a false negative may imply the input data sample is also a true positive and, as a result, the input data sample may be assigned to the predicted class (e.g., as a true positive). In some examples, the true positive group may be updated with the input data sample and the performance thresholds of the true positive group may be updated with the prediction performance metric of the instance in classifying the input data sample.

In an example, if the prediction distance does not satisfy the threshold distance for the false negative group (e.g., the prediction distance for the false negative group is equal to or greater than the threshold distance for the false negative group), the predicted class can be considered a true negative. The input data sample can be reclassified to the true negative group. The input data sample can then be used to update the true negative of the predicted class.

In some examples, once classified as a true negative, the input data sample may be compared to performance thresholds of a second confusion matrix corresponding to another class. The process here may be similar, for example, a determination can be made as to whether the prediction performance metric satisfies one of the performance thresholds of the other class. If so, then input data sample can be reclassified as such. If not, then the predicted class for the input data sample can be considered a true positive of the originally predicted class (e.g., a true positive) and used to update the true positive group.

In summary, if an input data sample is not initially considered a true positive, the input data sample may nonetheless be a true positive if it does not belong to any other group or class. In some examples, an input data sample determined to be a true positive (e.g., either initially or after comparison to other groups and/or classes) may be used to update the true positive group. The performance threshold of this group may be updated with the prediction performance metric of the instance in classifying the input data sample.

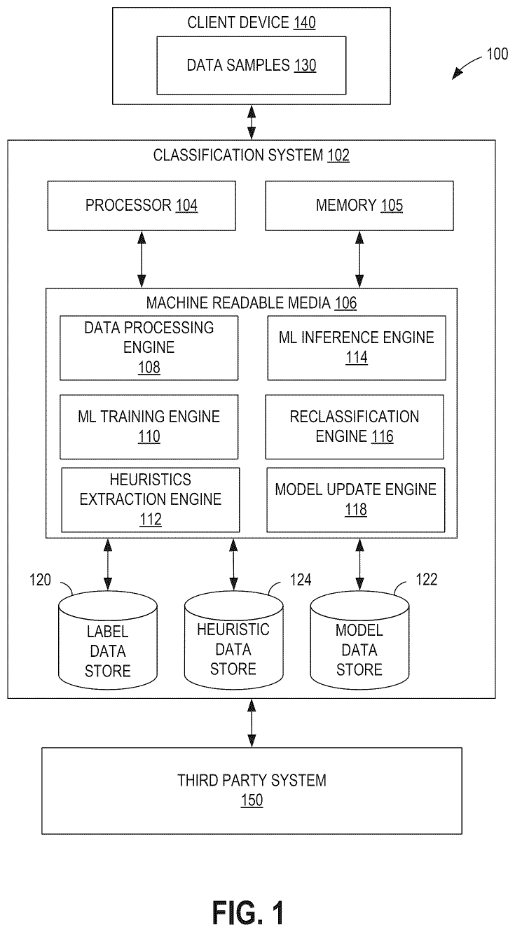

FIG. 1 depicts a schematic block diagram of an environment 100 for performing classifying data samples, in accordance with the examples disclosed herein. In the example of FIG. 1, classification system 102 comprises processor 104, memory 105, and machine readable media 106. Classification system 102 may be a server computer that communicates via network communications to other devices accessible on the network, including client device 140 and third party system 150. Classification system 102 may receive input data samples 130 from client device 140 and/or third party system 150 in a distributed communication environment.

Processor 104 may comprise a general-purpose or special-purpose processing engine such as, for example, a microprocessor, controller, or other control logic. Processor 104 may be connected to a bus, although any communication medium can be used to facilitate interaction with other components of classification system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carry one or more sequences of one or more instructions processor 104 for execution. Such instructions embodied on machine readable media 106 may enable classification system 102 to perform features or functions of the disclosed technology as discussed herein. For example, the interfaces, circuits, and modules of machine readable media 106 may comprise, for example, data processing module 108, ML training engine 110, heuristics extraction engine 112, ML inference engine 114, reclassification engine 116, and model update engine 118.

Data processing module 108 may be configured to receive data samples from client device 140 and/or third party systems 150, including end user devices, sensors, or software systems. The source of the data may comprise sensors, IoT devices, third party systems, or other end user devices. In some examples, the data is ingested by collecting, receiving, and storing the data samples.

The data samples may be generated by client device 140 and/or third party systems 150 corresponding to a sensor, IoT device, server, network equipment, or application installed thereon. In some examples, the source of the data may continuously generate the data samples, which can be transmitted via a network to classification system 102 and processed by data processing module 108. The transmission of the data may be transmitted using different protocols like HTTP, MATT, or custom protocols specific to the application or industry of the particular embodiment.

In some examples, the data samples received by the classification system 102 may be unlabeled data samples. The information received with the data samples can include a data packet header, payload, and/or metadata that is added during the transmission of the data. In this sense, the data packet header, payload, or metadata that is added during the transmission of the data may not correspond with a label added by classification system 102 later in the process. Instead, the label added by classification system 102 may correspond with data characteristics of the data sample that can identify the type of data upon analysis of the data packet, and the label added by classification system 102 may not be provided with the data sample as it is received by classification system 102.

ML training engine 110 may be configured to train unsupervised ML models and/or supervised ML models. For example, ML training engine 110 may be configured to train a supervised model, in which the model is trained to make distinctions between labeled training data sets and unlabeled training data sets. This training allows the models to recognize patterns and ultimately operate autonomously without using labels. In either case, the ML models trained by the ML training engine 110 may comprise a classification model.

Various training methods are described herein and implementation of any of these training methods will not divert from the essence of the disclosure.

In some examples, the unsupervised ML model may correspond with clustering (e.g., k-means, hierarchical clustering), dimensionality reduction (e.g., PCA, t-SNE), association rule learning, or other unsupervised ML models, as known in the art. Unsupervised ML models may be trained on training data sets of unlabeled data to assign or generate a label for the unlabeled training data. The label determined during the training process may be stored in label data store 120.

As noted above, ML training engine 110 may also be configured to train a supervised ML model. The supervised ML model may be trained using training data sets of labeled data that was determined from the unsupervised ML model and/or an operator and stored in label data store 120. In some examples, the supervised ML model may correspond with linear regression, decision trees, support vector machines, neural networks, or other supervised ML models.

Training the supervised or unsupervised ML model may begin by initializing the model with random or predefined parameters that can be adjusted during the training. When a label that is determined, the ML training engine may iteratively adjusts parameters of the model to minimize the difference between its predictions and true labels. In some examples, a loss function may also be implemented to quantify the error between the predicted outputs and the true labels. The loss function may be minimized during training.

In some examples, an optimization function can be implemented to adjust the parameters of the model iteratively. An illustrative process to adjust the parameters is gradient descent, although various optimization functions may be implemented. In some examples, the gradient of the loss function may be calculated with respect to the model parameters. The parameters may be updated in the opposite direction of the gradient to minimize the loss.

The trained ML model may be stored in a model data store 122 as a trained ML model. The trained ML model may be used during an inference process when new unlabeled data samples are received by classification system 102.

Heuristics extract engine 112 may be configured to extract heuristic data during the training (e.g., building) of the ML model. In examples, the heuristics extract engine 112 may extract heuristic data from the ML training engine 110 during the training process. For example, during the training process, the ML training engine 110 may compute performance metrics of the training, such as a performance metric for each instances of the training. As an illustrative example, the performance metrics can be computed in the form of probabilities that a given instance of training data belongs to each class that is the ML training engine 110 is being trained to classify. These probabilities can represent an accuracy of the instance of classification. From the performance metrics, the heuristics extract engine 112 may obtain heuristic data, such as a minimum of the performance metrics, a maximum of the performance metrics, an average (e.g., mean) of the performance metrics, and a standard deviation of the performance metrics. The heuristic data may be stored in heuristic data store 124 as metadata associated with each instance of training.

In examples, the heuristics extract engine 112 may also extract features of the training data that were used by from the ML training engine 110 during the training process. For example, each training data sample may comprise a set of features that were examined and used to classify the respective training data sample. The heuristics extract engine 112 may extract these sets of features as a feature vector that is associated with each training data sample as metadata.

In some examples, the ML training engine 110 may also be configured to verify the performance of the ML model during or at the conclusion of the training process. For example, a verification data set of unlabeled data may be applied to the trained ML model and checked against known labels to gauge the performance of the ML model. If the performance satisfies a desired threshold (e.g., 90% correctly classified or other desired performance), then the training process may be considered complete and the ML model stored to the model data store 122 for inferences. In this example, the heuristics extraction engine 112 may also obtain heuristic data from each instance of classification for the verification data set and store the heuristic data to the heuristic data store 124.

ML inference engine 114 may be configured to initiate an inference process using the trained models stored in model data store 122. The trained ML model may make predictions on classifications of unlabeled input data samples and generate labels that can be associated with or otherwise tagged to the input data samples. For example, once an ML model is trained, the ML model stored in model data store 122 can be deployed for inference of the new input data.

The inference process may comprise, for example, providing the unlabeled data to the trained ML model as input. The unlabeled data may be represented as a set of features, which the trained ML model may process to provide an inference. The processing of the data may vary based on the type of model to be implemented on the unlabeled data. For example, in a neural network, the model may receive the unlabeled data as input and process it through the layers of the neural network to generate output. The output of the neural network may provide determined similarities between features of training data and features of new input data (e.g., whether the new data is similar or not similar to the training data with respect to a similarity threshold). In decision trees, the model may receive the unlabeled data as input and process it through its decision boundaries. In either of these implementations, the model may generate a prediction that on whether or not the unlabeled input data belongs to a class corresponding to the similar training data based on similarities between features of the unlabeled input data and the training data. In some examples, the output may comprise a confidence score (also referred to as a probabilistic score) that the input data corresponds with the class (e.g., label of similar training data) or does not correspond with a class (e.g., outlier data).

ML inference engine 114 may also be configured to generate a set of clusters of labeled data as the prediction/output of the inference. In creating the set of clusters, the model may apply the learned patterns and relationships determined during training to the new data. In some examples, the model may generate clustered data with the highest probability of corresponding with the unlabeled data, and group each set of similar data (within a similarity threshold) in the common cluster. These clusters may represent different classes. In some examples, the output may comprise a confidence score that the data corresponds with the particular class (e.g., cluster) or does not correspond with any class (e.g., outlier data).

As alluded to above, the ML inference engine 114 may also be configured to generate a confidence score associated with each instance of the inference process that represents the likelihood that the input data sample is corresponds to a particular class. The confidence score may identify the probability that the ML model assigns to the prediction or classification of the input data. This confidence score may be stored to the heuristic data store 124 as metadata associated with each input data sample corresponding to an instance of the inference process.

Examples herein may implement various confidence scores. For example, a confidence score may be determined for each class and the greatest confidence score associated with the particular class may determine which class the input data sample are assigned. In other examples, if a confidence score for a class exceeds a predetermined threshold (e.g., 0.5 or 50%), the ML model might predict it as the belonging to the class. Otherwise, the ML model may predict the opposite (e.g., the input data does not belong to the class). In this sense, the thresholding of the confidence score may be used for classification.

The ML inference engine 114 may also be configured to generate a label for each instance of the inference process. For example, where the ML inference engine 114 predicts an input data samples corresponds to a particular class, the ML inference engine 114 may generate and assign a label representative of the class to the input data sample. The label determined during the inference process may be stored in label data store 120.

Reclassification engine 116 may be configured to evaluate the predicted classification and/or assigned label for an instance of the inference process performed by the ML inference engine 114. For example, based on (e.g., in response to) predicting a classification (e.g., belongs to or does not belong to a class) of an input data sample, the reclassification engine 116 may evaluate the “correctness” of the classification based on heuristic data stored in heuristic data store 124. Said another way, reclassification engine 116 may determine whether the predicted classification is actually a correct classification for the input data sample based on the heuristic data obtained while building or training the ML model.

In some examples, reclassification engine 116 may evaluate the classification prior to ML inference engine 114 generating a label for a predicted class. In this case, reclassification engine 116 may inform ML inference engine 114 of the evaluation, which may cause ML inference engine 114 to generate an appropriate label based on the evaluation. In some cases, the evaluation may indicate that the predicted class is incorrect and reclassify the input data sample to the appropriate class. In this case, ML inference engine 114 may generate a label for the appropriate class and assign the label to the input data sample. Alternatively, the evaluation may indicate that the predicted class is correct. In which case, the reclassification engine 116 may inform the reclassification engine 116 of such, which causes ML inference engine 114 to generate and assign the predicted label to the input data sample.

In another example, reclassification engine 116 may evaluate the classification after the ML inference engine 114 has assigned a predicted label to the input data sample. In this case, reclassification engine 116 may inform ML inference engine 114 of the evaluation, which may confirm that the assigned label is correct or cause the reclassification engine 116 to update the predicted label (e.g., generate and assign a new label to replace predicted label) to the appropriate label.

To provide for the evaluation, according to various examples, reclassification engine 116 may compare a classification (e.g., a measure of performance in predicting a class for an instance of the inference process on an input data sample and/or the input data sample) against performance thresholds derived from the heuristic data stored in heuristic data store 124 (e.g., data extracted during the training or retraining process). In examples, the measure of performance (e.g., the prediction performance metric) in predicting a class may be provided as a confidence score or accuracy of the prediction, similar to the performance metrics obtained for each classification instance during the training process. Reclassification engine 116 may determine a plurality of performance thresholds for each quadrant of a confusion matrix, for example, a heuristic-based threshold and a centroid-based threshold for each quadrant of the confusion matrix. Reclassification engine 116 may compare the predicted classification to one or more of the performance thresholds. The comparison may include determining whether or not the prediction performance metric satisfies the one or more of the performance thresholds. The comparison may also include determining whether or not the set of features for the input data sample is within a threshold distance of sets of features of training data constituting a quadrant of the confusion matrix. The predicted class can be updated based on the determination.

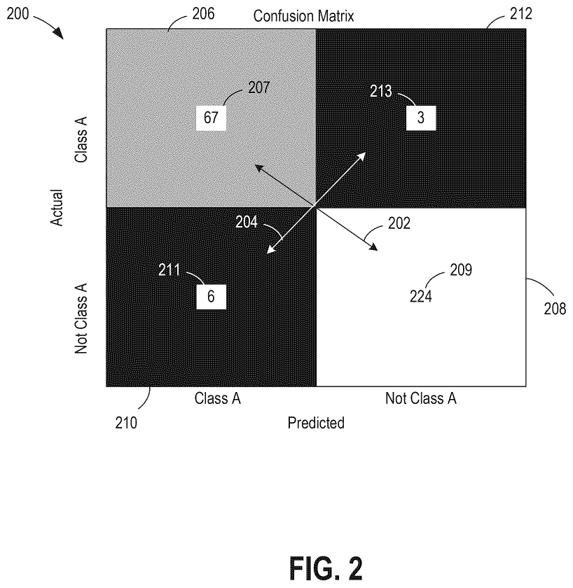

Reclassification engine 116 may be configured to construct the confusion matrix from the labeled data stored in label data store 120 based on the heuristic data stored in heuristic data store 124. A confusion matrix is a table that summarizes the performance of the ML model, an example of which is shown in FIG. 2.

Confusion matrix 200 comprises rows representing actual classes (e.g., class A and not class A in this example), while each column represents predicted classes for instances of the inference process. The diagonal 202 represent all instances that are correctly predicted, and the diagonal 204 represents all instances that are incorrectly predicted or misclassified. Numerical values in each quadrant correspond to the number of predictions that constitute a respective quadrant. Each quadrant 206, 208, 210, and 212, in this example, represents a particular group or category of the confusion matrix. For example, quadrant 206 represents a true positive group having a number 207 of predict instances, quadrant 208 represents a true negative group having a number 209 of predict instances, quadrant 210 represents a false positive group having a number 211 of predict instances, and quadrant 212 represents a false negative group having a number 213 of predict instances. By summing the numbers 207-213 of each row, examples herein can deduce a total number of positives (e.g., belonging to class A) and negatives (e.g., not belonging to class A). That is, for example, the total number of positives may be the sum of number 207 of true positives and number 213 of false negatives.

As FIG. 2 is an example, the numbers and classes provided are for illustrative purposes only. The specific numbers and classes may be based on the particular ML model implemented and the classifications performed thereby.

Determining the actual class may be performed in various ways. In one example, an administrator or other human may perform a manual review of each instance of classification and cause reclassification engine 116 to generate and assign a tag (e.g., categorize) each prediction instances as belonging to one of the quadrants 206-212 (e.g., one of the groups). These tags, which may be referred to as quadrant or group tags, may be stored in the heuristic data store 124. Additionally, the quadrant labels differ from the labels generated by the ML inference engine 114, which indicate a predicted class (also referred to as classification labels). That is, while the labels generated by ML inference engine 114 indicate a predicted class, the tags generated by reclassification engine 116 indicate if the predicted class is correct or a misclassification.

Reclassification engine 116 may be configured to derive the plurality of performance thresholds from the confusion matrix. For example, reclassification engine 116 may determine performance thresholds for each quadrant 206-212 of FIG. 2 based on performance metrics associated with the instances of a group that constitute a respective quadrant 206-212. In an illustrative example, reclassification engine 116 may determine performance thresholds based on performance metrics and/or computing one or more centroids for each respective group of the confusion matrix. In some examples, the centroids may be computed from a set of features feature, stored in heuristic data store 124, associated with the input data sample. For example, a first one or more centroids can be computed for the true positive group of quadrant 206 from the set of features of the input data sample, a second one or more centroids can be computed for the true negative group of quadrant 208, a third one or more centroids can be computed for the false negative group of quadrant 210, and a fourth one or more centroids can be computed for the false positive group of quadrant 212.

In an example, the performance thresholds of each quadrant 206-212 may comprise a first performance threshold (e.g., a heuristic-based threshold) and a second performance threshold (e.g., centroid-based threshold). In this case, the reclassification engine 116 may determine a heuristic-based performance threshold for a particular quadrant 206-212 as a function of performance metrics associated with the instances of a group that constitute a respective quadrant 206-212. The reclassification engine 116 may also determine a centroid-based threshold for each respective quadrant 206-212 as a threshold distance with respect to the one or more centroids of a respective quadrant 206-212. In examples, the threshold distance for a respective quadrant 206-212 may be based on the one or more centroids of another quadrant 206-212.

In an illustrative example, the heuristics extract engine 112 may obtain performance metrics of each instance of classification by a trained model (e.g., during training or inference). The performance metrics may include a confidence score of the particular instance belonging to a particular group. From the confidence scores of instances constituting a respective group, the heuristics extract engine 112 may obtain heuristic data, such as a minimum confidence score, a maximum confidence score, an average (e.g., mean) confidence score, and standard deviation of the confidence scores. Based on these heuristics, the reclassification engine 116 can check the predicted classification and/or assigned label for an instance of the inference process performed by the ML inference engine 114. For example, if prediction performance metric (e.g., confidence score of a given instance of classification) is less than average confidence score of a particular group, the reclassification engine 116 may determine that the instance does not belong to that group. In some cases, the standard deviation may be accounted for by checking if the performance metric is less than the average confidence score minus the standard deviation. As another example, if the performance metrics is less than minimum confidence score of a particular group, the reclassification engine 116 may determine that the instance does not belong to that group. The above examples may be considered instances whereby the prediction performance metric does not satisfy the heuristic-based threshold of a respective group. In these cases, the counter determinations may be considered as satisfying the heuristic-based threshold.

As alluded to above, reclassification engine 116 may determine the centroid-based thresholds for each respective quadrant as a threshold distance with respect to the one or more centroids of the respective quadrant. The threshold distance for a respective quadrant, in some examples, can be based on the set of features (e.g., feature vector) of input data sample and one or more centroids of another quadrant. For example, the threshold distance may be determined as a function of the distances between the one or more centroids of another quadrant and the input data sample represented as a feature vector. In some examples, distances between each centroid of the other quadrant and the feature vector of the input data sample can be computed. A threshold distance can be determined from these distances, for example, as an average of the distances, a minimum distance, and the like. In some cases, the threshold distance may also account for the standard deviation in the distances, for example, similar to how the standard deviation is account for above. In this way, the centroid-based thresholds for respective quadrants may be define as a threshold distance from the one or more centroids of the respective quadrant that the input data sample is expected to lie in order to satisfy the performance threshold of a respective group.

Reclassification engine 116 may also determine a prediction distance for each respective quadrant as a distance between the input data sample and the one or more centroids of a quadrant corresponding to a predict class (e.g., as predicted by the ML inference engine 114). The prediction distance for a respective quadrant, in some examples, can be based on the feature vector of the input data sample and the one or more centroids of the quadrant corresponding to the predicted class. For example, the prediction distance may be determined as a function of the distances between the one or more centroids and the input data sample represented as a feature vector. The prediction distance can be determined, for example, as an average of the distances, a minimum distance, and the like. In some cases, the prediction distance may also account for the standard deviation in the distances, for example, by adding or subtracting the standard deviation from the average or minimum distance, depending on the implementation. The reclassification engine 116 can then compare the prediction distance of a respective quadrant to a threshold distance of the respective quadrant to evaluate whether or not the input data point belongs to the respective quadrant.

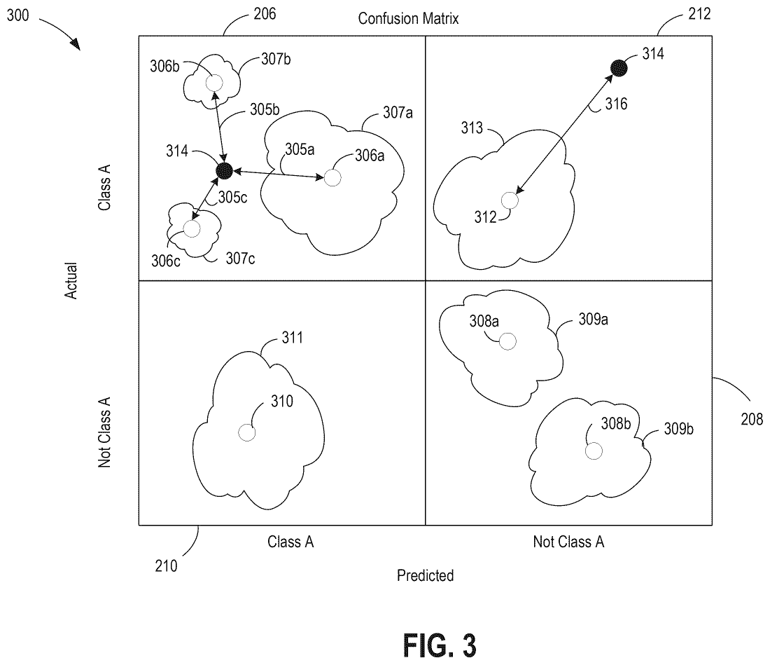

FIG. 3 illustrates a simplified example of performance thresholds (e.g., centroid-based thresholds) overlaid on the confusion matrix 200 of FIG. 2. In this example, the instances that constitute a given quadrant 206-212 can be clustered into clusters 307a-307c, 309a-30, 311, and 313, respectively. While a certain numbers of clusters are shown in each quadrant, this is for illustrative purposes only and any number of clusters may be formed in each quadrants depending on the algorithm used for the clustering. Centroids 306a-306c, 308a-308b, 310, and 312 can be computed from the feature sets of data samples associated with the instances that make up the clusters 307a-307c, 309a-30, 311, and 313, respectively.

In the case where input data sample 314 is predicted as belonging to class A, distances 305a-305c from the centroids 306a-306c to an input data point 314 may define a prediction distance. For example, centroids 306a-306c can be computed from the clusters 307a-307c, respectively, of data samples making up quadrant 206. Distances 305a-305c may be obtained, for example, as a distance between each centroid 306a-306c and the input data sample 314 as represented in quadrant 206 as a set of features. The prediction distance can be determined from these distances, for example, as an average of the distances, a minimum distance, and the like, for example, as described above in connection with FIG. 2.

In this example, threshold distances of quadrant 206 (corresponding to the predicted class may be based on distances between the input data sample 314 and one or more centroids of another quadrant. In this specific example, threshold distances of quadrant 206 (e.g., a true positive group) can be derived from quadrant 212 (e.g., the false negative group). In this example, distance 316 from the centroid 312 to the input data point 314 may define the threshold distance for quadrant 206 as a distance in which input data sample 314 is expected to lie in order to be considered as belonging to the group represented as quadrant 206. For example, centroids 312 can be computed from the cluster 312 of data samples making up quadrant 212. Distance 316 may be obtained, for example, as a distance between centroid 312 and the input data sample 314 as represented in quadrant 212 as a set of features. The threshold distance can be determined from these distances, for example, as described above in connection with FIG. 2.

Thus, for input data sample 314 to be considered as belonging to the true positive group of quadrant 206, the input data sample 314, represented as a set of features, is expected to be closer to the one or more centroids 306a-306c than the centroid 312.

While not depicted in FIG. 3, a threshold distance for quadrants 212 and 208 may be based on distances between the input data sample 314 represented as a feature vector and centroids 308a-309b and centroid 310, respectively.

In the case where an input data sample is predicted as not belonging to class A (e.g., a true negative corresponding to quadrant 208), a distance from the centroids 308a and 308b to the input data sample may define a prediction distance and a threshold distance for quadrant 208 can be determined from centroids of quadrant 210. A threshold distance for quadrant 210, in this example, can be determined from centroids of quadrant 206, and a threshold distance for quadrant 206 can be determined from centroids of quadrant 212.

The centroids can be computed by known techniques using the performance metrics of instances of classification corresponding to (e.g., constituting) a respective group. In some examples, the centroid may be computed using the elbow method or other known techniques.

In an illustrative example, referring back to FIG. 1, reclassification engine 116 may be configured to determine that the ML inference engine 114 has correctly classified the input data sample by comparing a the input data sample for this instance of classification to the centroid-based threshold (e.g., threshold distance from the centroid) for a true positive group of the confusion matrix. If the input data sample, represented as a set of features, satisfies the centroid-based threshold of the true positive group (e.g., the prediction distance is less than the threshold distance), reclassification engine 116 may determine that the predicted class belongs to the true positive group and tags the input data sample accordingly. The ML inference engine 114 recognizes the tag and either maintains an already generated label or generates and assigns a label to the input data sample.

However, if the input data sample does not satisfy the centroid-based threshold (e.g., the prediction distance is equal to or greater than the threshold distance for the true positive group), reclassification engine 116 may be configured to compare the input data sample to the centroid-based threshold of the false negative group. For example, the reclassification engine 116 may determine a prediction distance for the false negative group as the distance between the one or more centroids of the false negative group and the set of features of the input data sample. The reclassification engine 116 may determine a centroid-based threshold for the false negative group as the distance between the one or more centroids of the true negative group to the set of features of the input data sample. The reclassification engine 116 may then compare the prediction distance for the false negative group to the threshold distance of the false negative group.

If the input data sample satisfies the centroid-based threshold for the false negative group (e.g., the prediction distance for the false negative group is less than the centroid-based threshold for the false negative group), the predicted class can be considered a false negative (e.g., a positive). As a result, reclassification engine 116 may tag the input data sample as a positive. ML inference engine 114 may recognize the tag and either updates a label assigned to the input data sample or generates and assigns an appropriate label to the input data sample. In some examples, ML training engine 110 may retrain the ML model using the updated label and the heuristic data stored in heuristic data store 124 may be updated to include the prediction performance metric of the present instances, along with its corresponding set of features. Reclassification engine 116 may also be configured to update the performance thresholds for the true positive group based on the updated heuristic data stored in heuristic data store 124.

In an example, if the input data sample does not satisfy the centroid-based threshold for the false negative group, predicted class can be considered a true negative. As a result, reclassification engine 116 may reclassify the input data sample as a negative. The input data sample can then be used to update the true negative of the predicted class.

In some examples, upon not satisfying centroid-based threshold for the false negative group, the reclassification engine 116 may be configured to compare the input data sample to performance thresholds of a second confusion matrix corresponding to another class (e.g., class B in the case where confusion matrix 200 is a first confusion matrix). Reclassification engine 116 may perform a similar process to evaluate whether the input data sample belongs to a class of the second confusion matric. For example, if the prediction performance metric and/or input data sample satisfies one of the performance thresholds of the other class, the input data sample can be reclassified as such. If not, then the predicted class for the input data sample can be considered a positive of the initially predicted class and used to update the true positive group.

Model update engine 118 may be configured to review output from the ML inference engine 114 and/or reclassification engine 116 and update the ML model based on the outputs. For example, the labels determined during the inference process executed by ML inference engine 114 and/or reclassifying process executed by reclassification engine 116 may be provided back to the ML model to retrain the model during a subsequent training process. The retrained ML model may be stored in model data store 122 and/or provided for future inference processes on new input data samples that are received from, for example, client device 140 or third party system 150.

Unlabeled data 130 may comprise any data that is received at classification system 102 via network communications from client device 140. In some examples, client device 140 may generate unlabeled data, including network traffic, sensor data, firewall data, IoT data, or other telemetry data. The labeling aspect of the unlabeled data may correspond with a ML model that has associated a particular label to the unlabeled data from client device 140. The data generated by client device 140 may correspond with metadata or other characteristics of the data, without also corresponding with a label. In some examples, unlabeled data 130 may be aggregated and characterized by classification system 102 using data processing module 108 as described herein. In some examples, unlabeled data 130 is processed or filtered according to methods and systems described herein. Unlabeled data 130 may also be provided by third party system 150 according to various examples. As such, the described above regarding unlabeled data 130 from client device 140 may be substantially similar in the case of unlabeled data 130 received from third party system 150.

Client device 140 may be configured to generate, transmit, and receive data from classification system 102. Client device 140 may be any end user devices, sensors, or software systems. The source of the data may comprise sensors, IoT devices, satellite, third party entities, or other end user devices. The format of unlabeled data 130 may comprise a structured format, such as JSON, XML, or binary. In some examples, unlabeled data 130 is ingested by collecting, receiving, and storing the data generated by client device 140.

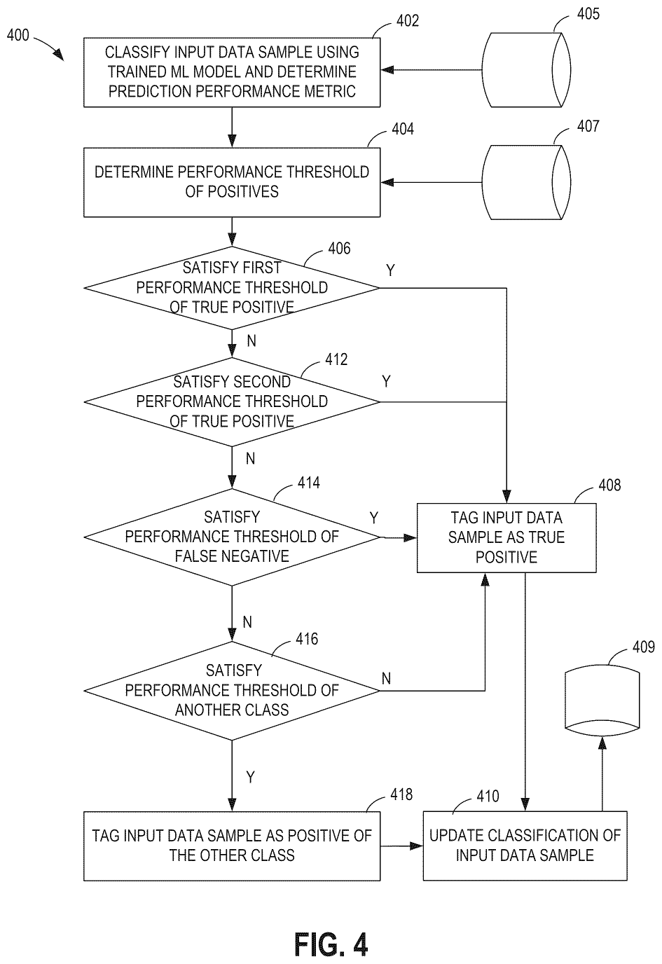

FIG. 4 illustrates an example process and database connections for classifying input data samples, in accordance with the examples disclosed herein. In examples, process 400 may be implemented as machine-readable instructions that may cause a processor to perform the operations described herein. In some examples, classification system 102 may be implemented to execute one or more operations disclosed herein.

At operation 402, an input data sample may be classified using a trained ML model (e.g., a classification model). For example, as described above in connection with FIG. 1, an ML model can be trained to classify data samples into one or more classes. In other words, the ML model may be trained to predict if a data sample belongs to a class or does not belong to a class (e.g., belongs to another class or is an outlier) based on a set of features that represents the data sample. The trained ML model may be trained in advance using training and verification data sets and stored in a model data store 405 (e.g., an example implementation of model data store 122). The input data sample may be applied to the trained ML model, which predicts whether or not the input data samples belongs to a class.

Operation 402 may also include determining a prediction performance metric for the classification instances of input data sample. As described above in connection with FIG. 1, the prediction performance metric may be provided as an accuracy of the prediction that the input data sample does or does not belong to the class. In examples, the accuracy may be represented provided as a probability that the input data sample corresponds to the predicted class (e.g., a confidence score). In some examples, the input data sample may be considered to belong to the class if the probability exceeds a predetermined threshold. The following description is will be made with an assumption that the ML model predicted that the input data sample belongs to the class.

In some examples, operation 402 may include generating and assigning a label indicative to the predicted class. The label may be stored in a label data store.

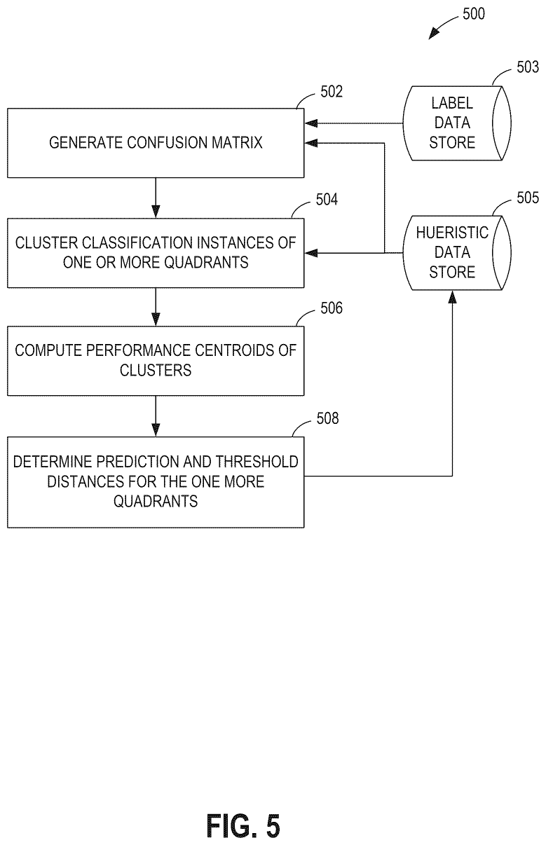

At operation 404, performance thresholds of positives may be determined based on heuristic data stored obtained from a heuristic data store 407 (e.g., an example implementation of heuristic data store 124). For example, positives may be represented in two ways: the ML correctly predicted that the input data sample corresponds to the class (e.g., a true positive) or the ML incorrectly predicted that the input data sample does not correspond to the class (e.g., a false negative). In examples, operation 404 may comprise determining a plurality of performance thresholds for positives. The plurality of performance threshold may include a first performance threshold (e.g., a heuristic-based threshold) and a second performance threshold (e.g., a centroid-based threshold). Operation 404 may include determining performance thresholds for both true positive and false negatives. FIG. 5 provides an example sub-process 500 that may be implemented as operation 404 to determine second performance thresholds.

In some examples, operation 404 may include determining the first performance threshold (e.g., heuristic-based threshold) as a function of performance metrics of positives. For example, operation 404 may obtain performance metrics from heuristic data store 407 and compute one or more of a minimum performance metric, a maximum performance metric, an average (e.g., mean) performance metric, and standard deviation performance metric. The first performance threshold may then be set from these heuristics. For example, the first performance threshold may be set as the average performance metric, the average performance metric minus the standard deviation, the minimum performance metric, and so on.

At determination 406, a determination is made on whether the prediction performance metric satisfies a first performance threshold for true positives determined at operation 404. As described above in connection with FIG. 1, if the prediction performance metric satisfies the first performance threshold (e.g., the heuristic-based threshold) of the true positives, the class predicted at operation 402 is considered a true positive (e.g., the ML model correctly classified the input data same).

In this case, process 400 proceeds to operation 408 and tags the input data sample as a positive. At operation 410, the classification predicted at operation 402 can be updated based on the tag and stored to label data store 409. For example, in the above example, since the predicted class was determined at determination 406 to be a true positive, the classification can be maintained and/or confirmed using the tag. In some examples, the label can be generated and assigned at or following operator 410 and stored in the label data store 409. In other examples, where a label is generated earlier in the process based on the predicted classification, the label stored in the label data store 409 can be maintained.

If the determination at determination 406 is negative (e.g., prediction performance metric does not satisfy the true positive heuristic-based threshold), the process 400 proceeds to determination 412.

At determination 412, a determination is made on whether the input data sample satisfies the second performance threshold (e.g., the centroid-based threshold) for true positives determined at operation 404. As described above in connection with FIGS. 1 and 3, if the input data sample satisfies the second performance threshold of the true positives, the class predicted at operation 402 is considered a true positive (e.g., the ML model correctly classified the input data same). In this case, process 400 proceeds to operation 408 and tags the input data sample as a positive. At operation 410, the classification predicted at operation 402 can be updated based on the tag and stored to label data store 409, as described above.

If the determination at determination 412 is negative (e.g., input data sample does not satisfy the true positive second performance threshold), the process 400 proceeds to determination 414. At determination 414, a determination is made as to whether or not the input data sample satisfies a performance threshold of false negatives (e.g., a centroid-based threshold). As described above in connection with FIGS. 1 and 3, if the input data sample satisfies the false negative performance threshold, the class predicted at operation 402 is considered a false negative (e.g., the ML model correctly classified the input data same). This determination indicates that the input data sample belongs to the vector space of the true positives and that the performance threshold for true positives may need to be updated to account for the input data sample. In this case, process 400 proceeds to operation 408 and tags the input data sample as a positive. At operation 410, the classification predicted at operation 402 can be updated based on the tag and stored to label data store 409, as described above.

If the determination at determination 414 is negative (e.g., input data sample does not satisfy the false negative performance threshold), the process 400 may proceed to determination 416 (or may proceed directly to one of operations 408 and 418). At determination 416, a determination is made as to whether or not the input data sample satisfies performance thresholds of another class. For example, the ML model (or another ML model) may be trained to classify input data samples into another class (aside from the predicted class). Like the above, performance thresholds can be determined for true positives and false negatives of this other class. In examples, determination 416 may include comparing the prediction performance metric to performance thresholds of a true positive and a false negative of the other class to determine if the input data sample belongs to the other class in a manner similar to determinations 412 and 414). If the determination at determination 416 is negative (e.g., the input data sample does not belong to the vector space of the other class), process 400 proceeds to proceeds to operation 408 and tags the input data sample as a positive of the class predicted at operation 402. At operation 410, the classification predicted at operation 402 can be updated based on the tag and stored to label data store 409, as described above.

However, if the determination at determination 416 is affirmative (e.g., the input data sample belongs to the vector space of the other class), process 400 proceeds to operation 418 and tags the input data as a positive of the other class. The process 400 then proceeds to operation 410 where the classification predicted at operation 402 can be updated based on the and an appropriate label can be generated, assigned, and stored to the label data store 409.

In some examples, if the determination at determination 416 is negative, determination 416 may determine that the input data sample belongs to the performance threshold that the prediction performance metric is closest too. For example, determination 416 may include determining a magnitude of the difference between the input data sample and the second performance threshold of the true positive for the predicted class and a magnitude of the difference between the input data sample and the second performance threshold of the true positive for the other class. Determination 416 may identify which magnitude is smallest (e.g., which performance threshold the prediction input data sample is closest too). Determination 416 may proceed to operation 408 if the input data sample is closer to the true positive performance threshold of the predicted class or determination 416 may proceed to operation 418 if the prediction performance metric is closer to the true positive performance threshold of the other class.

While the foregoing example was described for a case in which the ML model predicted the input data sample belongs to the predicted class, examples herein can be implemented in a similar manner in a case where the ML model predicts that the input data sample does not belong to the predicted class at operation 402. In this case, performance thresholds for negatives could be determined at operation 404 (e.g., performance thresholds for true negatives and false positives) opposed to positives, and determinations 406, 412, and 414 may compare the prediction performance metric and/or input data sample to performance thresholds for the true negatives and false positives, respectfully. Determination 416, in this example, may compare the input data sample to negatives of the other class as well to determine which vector space the input data sample does not belong.

FIG. 5 illustrates an example sub-process 500 and database connections for determining example performance thresholds, in accordance with the examples disclosed herein. Sub-process 500 is an example for determining second performance thresholds as described above. In examples, sub-process 500 may be implemented as machine-readable instructions that may cause a processor to perform the operations described herein.

At operation 502, a confusion matrix can be generated, for example, from labeled data stored in label data store 503 (e.g., label data store 409 of FIG. 4) and heuristic data (e.g., metadata) associated with the label data stored in heuristic data store 505 (e.g., heuristic data store 407 of FIG. 4). As described above, for example, while training the trained ML model used in operation 402 above data can be classified and heuristic data (e.g., performance metrics) can be obtained. Heuristic data may include tags that indicate the correctness of the label associated with the labeled data, such as a true positive, true negative, false positive or false negative tag. From this data, a confusion matrix, such as the confusion matrix shown in FIG. 2, can be generated that includes four quadrants, one for each tag. Each quadrant may contain those instances of classification (during the training/verification process) that are tagged with a tag corresponding to that quadrant. For example, a true positive quadrant (or group) comprises those classification instances that are tagged as true positive, a false positive quadrant (or group) comprises those classification instances that are tagged as false negatives, and so on.

At operation 504, the classification instances of one or more quadrants can be clustered according to known clustering algorithms. For example, classification instances tagged as true positives can be clustered into one or more clusters, classification instances tagged as false negatives can be clustered into another one or more clusters, and so on. Classification instances, in various examples, can be clustered according to performance metrics of those classifications instances constituting a quadrant. The performance metrics can be obtained from the heuristic data store 505.

At operation 506, one or more centroids can be computed for each of the one or more clusters. The one or more centroids can be computed by known techniques using the feature sets of instances of classification corresponding to (e.g., constituting) a respective group. In some examples, the one or more centroids may be computed using the elbow method or other known techniques. The one or more centroids may be computed from the features sets, stored in heuristic data store 505, associated with the instances that constitute a respective quadrant. FIG. 3 illustrates examples centroids.

At operation 508, prediction distances and threshold distances of each of the one or more quadrants can be determined. For example, a prediction distance for each quadrant can be determined as a distance from the input data sample to the one or more centroids of each quadrant from operation 506. In examples, the prediction distance may be determined as a function of the set of features representing the input data sample to the one or more centroids of each quadrant. For example, the input data sample can be represented as a set of features and distances can be computed from the set of features to each of the one or more centroids using the feature vector and each centroid as coordinates (e.g., x and y coordinates in the case of a two dimensional feature vector or a N coordinates in the case of a N dimensional feature vector). A prediction distance of a given quadrant can be determined from these distances, for example, as an average of the distances, a minimum distance, and the like. In some cases, the prediction distance may also account for a standard deviation in the distances. The threshold distance for each quadrant may be determined in a similar manner (e.g., as a distance from the input data sample to one or more centroids), except that the threshold for a given quadrant is computed using the one or more centroids of an adjacent quadrant. In some examples, the threshold distances may be considered an example of the second performance thresholds (e.g., centroid-based thresholds) of a given quadrant, which can be stored to the heuristic data store 505 along with the prediction distances.

In this example, with reference to FIG. 4, determination 412 may include comparing a prediction distance for the true positive group (determined according to process 500) to a threshold distance for the true positive group (determined according to process 500). In this example, the prediction distance may be determined as a distance between the input data sample from operation 402 and the one or more centroids of the true positive group determined at operation 510. The threshold distance for determination 412 may be determined as the distance between the input data sample and the one or more centroids of the false negative group determined at operation 510. If the prediction distance is less than the threshold distance, then the determination at determination 412 is affirmative. Otherwise, the determination at determination 412 is negative.

Similarly, determination 414 may include comparing a prediction distance for the false negative group to a threshold distance for the false negative group. In this case, the prediction distance may be determined as a distance between the input data sample and the one or more centroids of the false negative group. The threshold distance may be determined as the distance between the input data sample and the one or more centroids of the true negative group. If the prediction distance is less than the threshold distance, then the determination at determination 414 is affirmative. Otherwise, the determination at determination 414 is negative. Further still, determination 416 may include comparing a prediction distance to a threshold distance for the negatives of the other class. If the prediction distance is equal to or less then the threshold distances, then the determination at determination 416 is affirmative. Otherwise, the determination at determination 416 is negative.

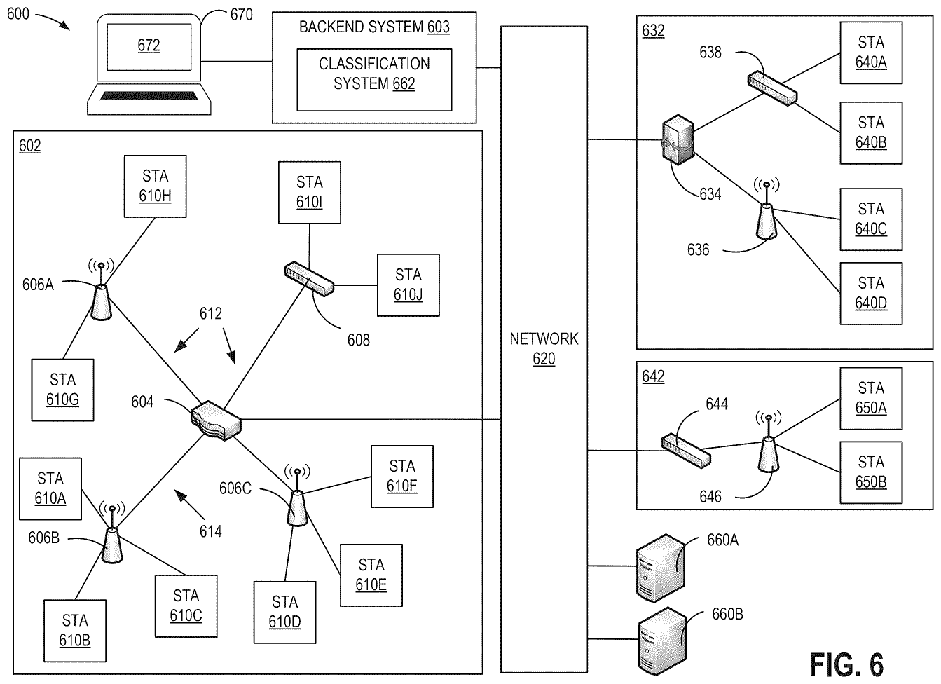

It may be useful to describe an example network installation with which the examples disclosed herein might be implemented in various applications. FIG. 6 illustrates a system 600 in which various of the examples presented herein may be implemented. The system 600 may include an IT infrastructure 601 and a backend system 603 that aids in managing security aspects of the IT infrastructure 601. The backend system 603 may be hosted on a network outside the IT infrastructure 601 or within the IT infrastructure 601. In some examples, the backend system 603 may be deployed on a cloud platform hosted on a public, private, or hybrid cloud outside the IT infrastructure 601.

The IT infrastructure 601 may be a network of devices (hereinafter referred to as network devices) implemented for an organization, such as a business, educational institution, governmental entity, healthcare facility, or other organization. This diagram illustrates an example IT infrastructure implemented for an organization having multiple users and possibly one or more physical or geographical sites, for example, a primary site 602, and/or remote sites 632, 642. The primary site 602 and/or the remote sites 632, 642 are in communication with each other via a network 620. Although, in some examples, the IT infrastructure 601 may be implemented with a single site, without limiting the scope of the present disclosure.

The primary site 602 may include a primary network, which can be, for example, an office network, home network, or other network installation. The primary site 602 may be a private network, such as a network that may include security and access controls to restrict access to authorized users of the private network. For example, the authorized users may include employees of a company at the primary site 602, residents of a house, customers at a business, and so on. In the illustrated example, the primary site 602 is shown to include a controller 602 in communication with the network 620. The controller 604 may provide communication with the network 620 for the primary site 602, though it may not be the only point of communication with the network 620 for the primary site 602. A single controller 604 is illustrated, though the primary site 602 may include multiple controllers and/or multiple communication points with network 620. In some examples, the controller 604 may communicate with the network 620 through a router (not shown). In other implementations, the controller 604 may provide router functionality to the devices in the primary site 602.

The controller 604 may be operable to configure and manage network devices, such as at the primary site 602, and may also manage network devices at the remote sites 632, 642. The controller 604 may be operable to configure and/or manage switches, routers, APs, and/or client devices connected to a network. The controller 604 may itself be, or provide the functionality of, an AP. In some examples, the controller 604 may be in communication with one or more switches 608 and/or wireless APs 606A-606C. The switches 608 and the wireless APs 606A-606C may provide network connectivity to various client devices 610A-610J. Using a connection to the switch 608 or one or more of the AP 606A-606C, one or more of the client devices 610A-610J may access network resources, including other devices on the (primary site 602) network and the network 620. Examples of client devices 610A-610J may include, but are not limited to, desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, IOT devices, and the like.

Within the primary site 602, the switch 608 is included as one example of a point of access to the network established in primary site 602 for wired client devices 610I and 610J, for example. The client devices 610I and 610J may connect to the switch 608 and through the switch 608, may be able to access other devices within the IT infrastructure 601. The client devices 610I and 610J may also be able to access the network 620, through the switch 608. The client devices 610I and 610J may communicate with the switch 608 over a wired connection 612. In the illustrated example, the switch 608 may communicate with the controller 604 over a wired connection 612, though this connection may also be wireless, in some examples.

The wireless APs 606A-606C are included as another example of a point of access to the network established in primary site 602 for client devices 610A-610H. Each of APs 606A-606C may be a combination of hardware, software, and/or firmware that is configured to provide wireless network connectivity to wireless client devices 610A-610H. In the illustrated example, the APs 606A-606C can be managed and configured by the controller 604. The APs 606A-606C may communicate with the controller 604 and the network 620 over connections 612, which may be either wired or wireless interfaces.

The IT infrastructure 601 may include one or more remote sites 632. A remote site 632 may be located in a different physical or geographical location from the primary site 602. In some cases, the remote site 632 may be in the same geographical location, or possibly the same building, as the primary site 602, but lacks a direct connection to the network located within the primary site 602. Instead, the remote site 632 may utilize a connection over a different network, e.g., the network 620. The remote site 632 such as the one illustrated in FIG. 6 may be, for example, a satellite office, another floor, or suite in a building, and so on. The remote site 632 may include a gateway device 634 for communicating with the network 620. The gateway device 634 may be a router, a digital-to-analog modem, a cable modem, a Digital Subscriber Line (DSL) modem, or some other network device configured to communicate to the network 620. The remote site 632 may also include a switch 638 and/or an AP 636 in communication with the gateway device 634 over either wired or wireless connections. The switch 638 and the AP 636 may provide connectivity to the network for various client devices 640A, 640B, 640C, and 640D (hereinafter collectively referred to as client devices 640A-640D).

In various examples described herein, the remote site 632 may be in direct communication with the primary site 602, such that client devices 640A-640D at the remote site 632 access the network resources at the primary site 602 as if these client devices 640A-640D were located at the primary site 602. In such examples, the remote site 632 may be managed by the controller 604 at the primary site 602, and the controller 604 may provide the necessary connectivity, security, and accessibility that enable the remote site 632's communication with the primary site 602. Once connected to the primary site 602, the remote site 632 may function as a part of a private network provided by the primary site 602.

In various examples, the IT infrastructure 601 may include one or more smaller remote sites 642, comprising a gateway device 644 for communicating with the network 620 and a wireless AP 646, by which various client devices 650A, 650B access the network 620. Such a remote site 642 may represent, for example, an individual employee's home or a temporary remote office. The remote site 642 may also be in communication with the primary site 602, such that the client devices 650A, 650B at remote site 642 access the network resources at the primary site 602 as if these client devices 650A, 650B were located at the primary site 602. The remote site 642 may be managed by the controller 604 at the primary site 602 to make this transparency possible. Once connected to the primary site 602, the remote site 642 may function as a part of a private network provided by the primary site 602.

The network 620 may be a public or private network, such as the Internet, or another communication network to allow connectivity among the various sites 602, 632, 642, and the backend system 603. The network 620 may include third-party telecommunication lines, such as phone lines, broadcast coaxial cable, fiber optic cables, satellite communications, cellular communications, and the like. The network 620 may include any number of intermediate network devices, such as switches, routers, gateways, servers, and/or controllers, which are not directly part of the IT infrastructure 601 but that facilitate communication between the various parts of the IT infrastructure 601, and between the IT infrastructure 601 and other network-connected entities.

The backend system 603 hosts a classification system 662 that is communicatively coupled to the IT infrastructure 601 via the network 620. The classification system 662 may be a computing system, for example, a computer, a controller, a server, or a storage system hosted on a public cloud, a private cloud, or a hybrid cloud. In certain examples, the classification system 662 may be any suitable device having a hardware processing resource (not shown), such as one or more central processing units (CPUs), semiconductor-based microprocessors, and/or other hardware devices suitable for retrieval and execution of instructions stored in a machine-readable storage medium (not shown). In some examples, the classification system 662 may be implemented as a service running on a “cloud computing” environment or as a “software as a service” (SaaS). The classification system 662 may be offered as a stand-alone product, a packaged solution, and can be utilized on a one-time full product/solution purchase or pay-per-use basis.

In accordance with some examples, the classification system 662 may be an example implementation of classification system 102 of FIG. 1. In this case, the various components of the IT infrastructure may be examples of client device 130 and/or third party systems 140. In examples, the classification system 662 may be configured to classify data flowing in IT infrastructure 601 using a trained ML model as anomalous activity and reclassify misclassified activity, which can be used to detect network attacks and evaluate vulnerability to the IT infrastructure 601. In some examples, based on the evaluation, the classification system 662 may also recommend corrective actions (e.g., a firmware update, a software update, a configuration change, a security patch, etc.) for the network devices that are found vulnerable. Thus, the IT infrastructure 601 may remain unaffected by the adverse impacts of the network attack. Moreover, the management system 662 performs such evaluation with minimal or no human intervention.

In a particular example, classification system 662 proactively collects information about network vulnerabilities, such as DNS over HTTPS (DoH) traffic in real-time, and recommends corrective actions. The use of (DoH) in networked environments, such as IT infrastructure 610 has increased, which emphasizes a need for robust and secure network connectivity and the protection of network devices against external attacks. The increased usage of DoH protocols has rendered conventional methods for classification and identification network traffic as less effective. DoH provides encryption, making it challenging to detect and classify between DoH and non-DoH traffic. This poses a challenge for network administrators and security teams who rely on traffic analysis for threat detection, network performance optimization, and policy enforcement. The classification system 662 combines traffic insight, deep packet inspection (DPI), and machine learning algorithms to detect and classify DoH and non-DoH traffic in real-time. The methodology involves training an ML model on processed data packets and selecting attributes, such as but not limited to, packet length and flow rate, to create a classification model capable of classifying DoH and non-DoH traffic. In an example, training of the classification model can be done by the ML training engine 110 of FIG. 1. The classification system 662 may be implemented to evaluate the classifications of the data traffic and reclassify misclassifications, as described above in connection with FIGS. 1-5.

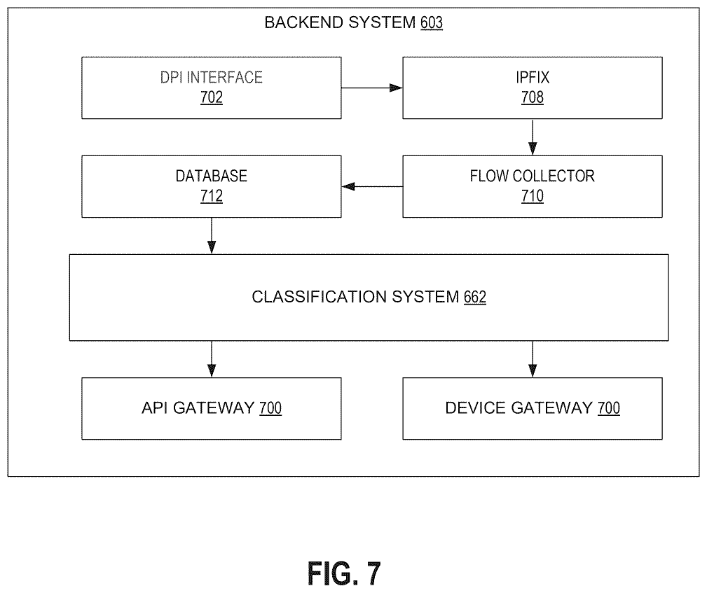

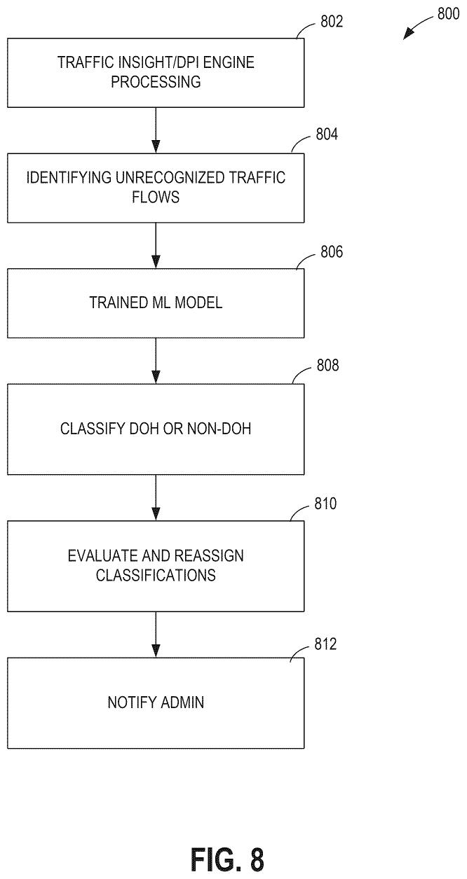

FIG. 7 illustrates a schematic block diagram of backend system 603. In some examples, the backend system 700 may host the classification system 662, a DPI interface 702, and a device gateway 704, an application programming interface (API) gateway 706, an Internet Protocol Flow Information Export 708, a flow collector 710, and an Open vSwitch Database 712. FIG. 8 illustrates an example process flow for classifying DoH traffic using backend system 603, according to an example implementation of the disclosed technology.

At step 802 of FIG. 8, DPI interface 702 is a feature that allows for analysis of network traffic by inspecting individual packets. When enabled on a traffic-flowing interface, DPI interface 702 provides deep inspection of the packet flow, allowing for the recognition of the application associated with the flow. The recognized application information can be reported to the Internet Protocol Flow Information Export (IPFIX) 708, which is a network flow analysis tool embedded in backend system 603. The IPFIX 708 may be configured to compile measured properties of the flows, obtained by DPI interface 702, and sends the flow report to the flow collector 710, which in this case may be a Traffic Insight feature. The flow collector 710 collects these records and updates the traffic information in an Open vSwitch Database (OVSDB) 712. The available information in the OVSDB 712 for the flows may include, but is not limited to, Source IP Address, Destination IP Address, Source Port, Destination Port, Protocol, Application name, and Counters (number of packets & bytes).

Classification system 662 may be configured to classify flow records whose application name is unrecognized by the backend system 603. At step 804, unrecognized application traffic flows can be identified. These unrecognized flow records can be converted into a dataset. The ML model may be trained (step 806) from flow datasets obtained from the OVSDB 712. Each record can be classified by the ML model as either DoH or not (step 808). The ML model can be triggered whenever an unknown application entry is added to the OVSDB 712. The classification of a traffic flow as a DoH traffic (e.g., belonging to a predicted class) or non-DoH traffic (e.g., not belonging to a predicted class) can be evaluated and reassigned, as needed, at step 810. For example, at step 810, classification system 662 may be configured to execute process 400 of FIG. 4, which may include sub-process 500 of FIG. 5. The classification results can be updated back to the OVSDB 712 for the corresponding flow entry. This information can be accessed via REST API and can be viewed in a dashboard 672 running on a front-end system 670 (step 812). Based on these notifications, a network administrator can further examine the situation and take corrective action, such as rerouting to a firewall.

The device gateway 704 may be a hardware device or software application that acts as a “gate” between the backend system 603 and the IT infrastructure 601. Communication between the management system 662 and components deployed in the IT infrastructure 601 may be routed via the device gateway 704.

The API gateway 706 may be software or a service offered via a cloud platform hosting the backend system 603. The API gateway 706 may allow developers to create, publish, maintain, and/or monitor APIs such as representational state transfer (REST) APIs and/or WebSocket APIs. In some examples, the API gateway 706 may be used to publish data to an API of the front-end dashboard 672 hosted on a user portal. In particular, the management system 662 may communicate information associated with the classifications the front-end dashboard 672 via the API gateway 706. The API gateway 706 publishes such information to the API of the front-end dashboard 672, which in turn displays the information on the dashboard.

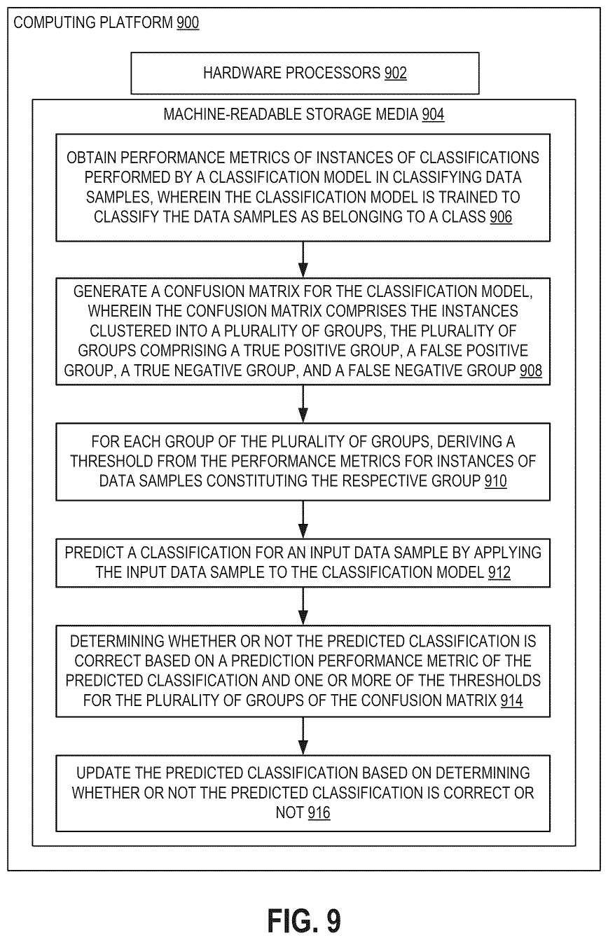

FIG. 9 illustrates a computing component that may be used to implement classifying data sample in accordance with various examples of the disclosed technology. Referring now to FIG. 9, computing component 900 may be, for example, a server computer, a controller, or any other similar computing component capable of processing data. In the example implementation of FIG. 9, the computing component 900 includes a hardware processor 902, and machine-readable storage medium 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-916, to control processes or operations classifying data samples. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 314, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-916.

Hardware processor 902 may execute instruction 906 to obtain performance metrics of instances of classifications performed by a classification model in classifying data samples, wherein the classification model is trained to classify the data samples as belonging to a class. For example, as described above in connection with FIGS. 1-8, a classification model can be trained on training data and performance metrics of the training (e.g., heuristic data) can be extracted and stored to a data store during the training process. The performance metrics may comprise a confidence score of the instances, for example, a probability that the data of a given instance belongs to (e.g., corresponds to) the class.

Hardware processor 902 may execute instruction 908 to generate a confusion matrix for the classification model. As described above in connection with FIG. 1, and as shown in FIG. 2, the confusion matrix may comprise the instances clustered into a plurality of groups. In examples, the plurality of groups may include a true positive group, a false positive group, a true negative group, and a false negative group.

Hardware processor 902 may execute instruction 910 to, for each group of the plurality of groups, derive a threshold from the performance metrics for instances of data samples constituting the respective group. For example, processor 902 may execute instruction 910 to determine, for each group of the confusion matrix, a first performance threshold as a function of performance metrics, for example, based on an average, minimum, standard deviation, and so on. In some examples, processor 902 may also execute instruction 910 to determine a second performance threshold by, for each group of the confusion matrix, clustering the instances into the plurality of groups based on the performance metrics, and deriving one or more centroids from the performance metrics for the instances of the data samples constituting the respective group. A threshold distance can be computed based on the one or more centroids of a group adjacent to the respective group. For example, the threshold distance for each group may be based on a distance between the input data sample (e.g., represented as a set of features) and the one or more centroids of the adjacent group. In some examples, processor 902 may also execute instruction 910 to, for each group of the plurality of groups, determine a prediction distance from the one or more centroids of a respective group to the input data sample. Further details are provided in the examples described in connection with FIGS. 1-8.

Hardware processor 902 may execute instruction 912 to predict a classification for an input data sample by applying the input data sample to the classification model.

Hardware processor 902 may execute instruction 914 to determine whether or not the predicted classification is correct based on a prediction performance metric of the predicted classification and one or more of the thresholds for the plurality of groups of the confusion matrix. The determination, in some examples, may be based on a first performance threshold, a second performance threshold, or a combination of performance thresholds. In various examples, the determination may be based on the performance metrics obtained at instructions 906. For example, a first threshold may be determined from the performance metrics and the prediction performance metric can be compared therewith, as described above in connection with FIGS. 1 and 3-5. Furthermore, the determination, in some examples, may also be based on the one or more of the centroids computed during execution of instructions 910. In further details, the determination may include comparing the prediction distance of a respective group to the threshold distance of the respective group.

Hardware processor 902 may execute instruction 916 to update the predicted classification based on determining whether or not the predicted classification is correct or not. In some examples, updating the predicted classification may include confirming or otherwise maintaining the predicted classification, for example, where the comparison indicates that the predicted classification corresponds to the actual classification (e.g., is correct). In another example, updating the predicted classification may include reclassifying or reassigning a classification, for example, where the comparison indicates that the predicted classification does not correspond to (e.g., does not match) the actual classification (e.g., is misclassified). In some examples, upon updating the classification, processor 902 may execute instruction 914 to cause a label, previously assigned to the input data sample based on the predicted classification, to be updated accordingly. In another example, processor 902 may execute instruction 914 to generate and assign a label to the input data sample based on the updated classification.

In an illustrative example, the classification model may predict that the input data sample corresponds to the class (instructions 912). In this case, the predication performance metric can be compared to a first performance threshold that is based on the performance metrics of the true positive group of the confusion matrix and the prediction distance from the set of features of the input data sample can be compared to a threshold distance that is based on the one or more centroids of the false negative group. In some cases, responsive to a determination that the prediction performance metric is less than the first performance threshold and that the prediction distance exceeds the threshold distance of the true positive group, processor 902 may execute instruction 914 to determine a prediction distance from the set of features for the input data sample to the one or more centroids of the false negative group. Processor 902 may then execute instructions 914 to compare this prediction distance to the threshold distance of the false negative group, which is based on the one or more centroids of the true negative group. Responsive to a determination that the prediction distance is less than the threshold distance of the false negative group, processor 902 may execute instruction 914 to classifying the input data sample as a belonging to the class. Whereas, responsive to a determination that the prediction distance exceeds the threshold distance of the false negative group, processor 902 may execute instruction 914 to evaluate the input data sample relative to one or more threshold distances of a second classification matrix corresponding to another class and execute instructions 916 to reclassify the input data sample as a belonging to another class based on the evaluation. Further details and examples are provided above in connection with FIGS. 1 and 3-5.

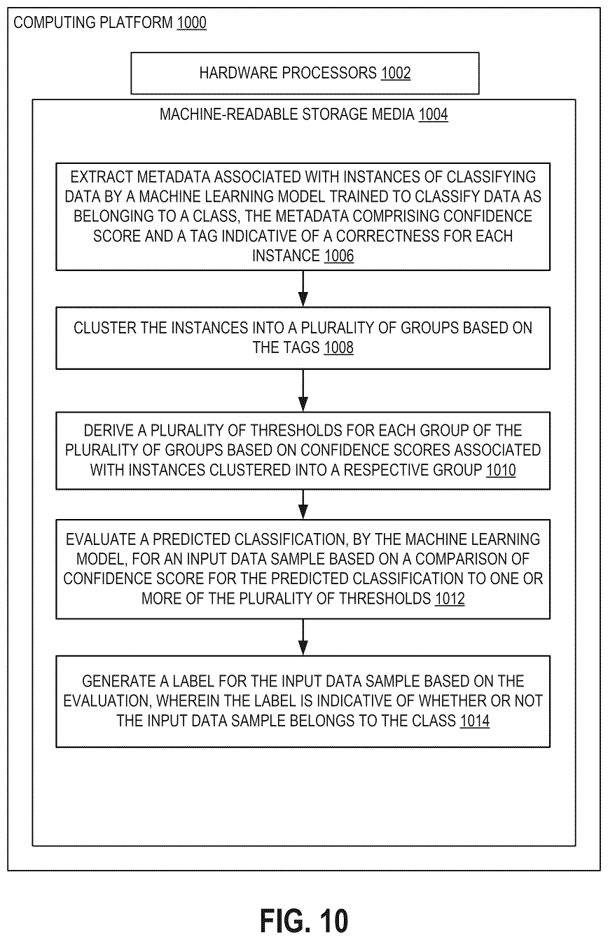

FIG. 10 illustrates a computing component that may be used to implement classifying data sample in accordance with various examples of the disclosed technology. Referring now to FIG. 10, computing component 1000 may be, for example, a server computer, a controller, or any other similar computing component capable of processing data. In the example implementation of FIG. 10, the computing component 1000 includes a hardware processor 1002, and machine-readable storage medium 1004.

Hardware processor 1002 may be one or more central processing units (CPUs), semiconductor-based microprocessors, and/or other hardware devices suitable for retrieval and execution of instructions stored in machine-readable storage medium 1004. Hardware processor 1002 may fetch, decode, and execute instructions, such as instructions 1006-1014, to control processes or operations classifying data samples. As an alternative or in addition to retrieving and executing instructions, hardware processor 1002 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 314, may be any electronic, magnetic, optical, or other physical storage device that contains or stores executable instructions. Thus, machine-readable storage medium 1004 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1004 may be a non-transitory storage medium, where the term “non-transitory” does not encompass transitory propagating signals. As described in detail below, machine-readable storage medium 1004 may be encoded with executable instructions, for example, instructions 1006-1014.

Hardware processor 1002 may execute instruction 1006 to extract metadata associated with instances of classifying data by a machine learning model trained to classify data as belonging to a class, the metadata comprising confidence score and a tag indicative of a correctness for each instance.

Hardware processor 1002 may execute instruction 1008 to cluster the instances into a plurality of groups based on the tags. As described above in connection with FIGS. 1-8, the plurality of groups may comprise a true positive group, true negative group, false positive group, and false negative group. In some examples, the clustering may be utilized to construct a confusion matrix (e.g., FIG. 2). In examples, the confidence score may comprise a probability that data of an instance corresponds to the class, which may be determined during a training phase of the machine learning model.

Hardware processor 1002 may execute instruction 1010 to derive a plurality of thresholds for each group of the plurality of groups based on confidence scores associated with instances clustered into a respective group.

Hardware processor 1002 may execute instruction 1012 to evaluate a predicted classification, by the machine learning model, for an input data sample based on a comparison of confidence score for the predicted classification to one or more of the plurality of thresholds. For example, processor 1002 may execute instruction 1012 to determine a first plurality of thresholds of the plurality of thresholds from the confidence scores associated with instances clustered into the plurality of groups. Processor 1002 may also execute instruction 1012 to compute one or more centroids for each group of the plurality of groups based on the feature sets for the instances constituting a respective group. For each group, processor 1002 may execute instruction 1012 to determine a second threshold of the plurality of thresholds based on distances from the input data sample to the one or more centroids of another group of the plurality of groups. Processor 1002 may also execute instruction 1012 to, for each group of the plurality of groups, determine a prediction distance from a set of features of the input data sample to the one or more centroids of the respective group. In this case, evaluating the predicted classification may include one or more of comparing the confidence score for the predicted classification to one or more of the first plurality of thresholds and comparing the prediction distance of a respective group to the threshold of the respective group, for example, as described above in connection with FIGS. 1, 4, and 5.

Hardware processor 1002 may execute instruction 1014 to generate a label for the input data sample based on the evaluation, for example, as described on connection with FIGS. 1 and 4. The label, in various examples, may be indicative of whether or not the input data sample belongs to the class.

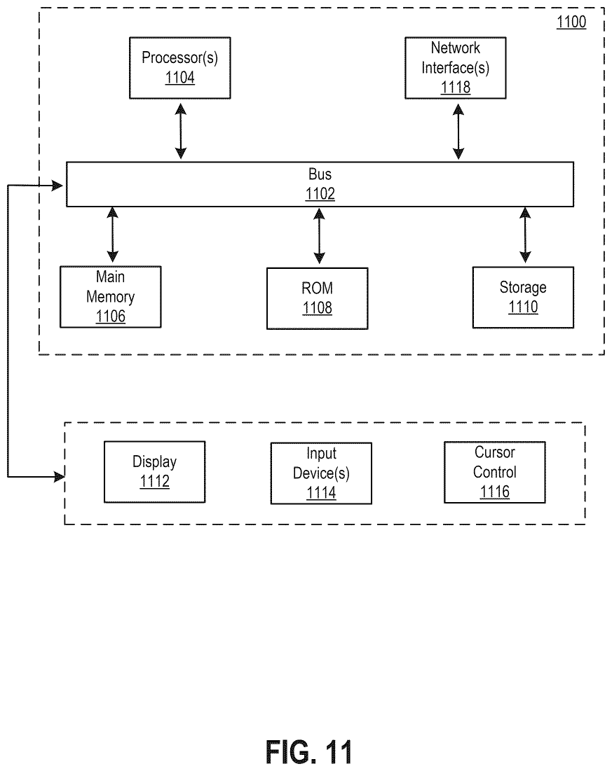

FIG. 11 depicts a block diagram of an example computer system 1100 in which various examples of the disclosed technology described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors. The computer system 1100 may be implemented as one or more components of the environment of FIG. 1 and/or components of the IT infrastructure described in connection with FIGS. 6 and 7.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions. For example, main memory 1106 may store instructions, that when executed by processor(s) 1104, cause computer system 1100 to perform one or more of the operations described in connection with FIGS. 4, 5, and/or 8.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some examples, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one example of the disclosed technology, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes a network interface 1118 (also referred to as a communication interface) coupled to bus 1102. Network interface 1118 provides a two-way data communication coupling to one or more network links that are connected to one or more local networks. For example, network interface 1118 may be an integrated services digital network (ISDN) card, cable modem, satellite modem, or a modem to provide a data communication connection to a corresponding type of telephone line. As another example, network interface 1118 may be a local area network (LAN) card to provide a data communication connection to a compatible LAN (or WAN component to communicated with a WAN). Wireless links may also be implemented. In any such implementation, network interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 1118, which carry the digital data to and from computer system 1100, are example forms of transmission media.

The computer system 1100 can send messages and receive data, including program code, through the network(s), network link and network interface 1118. In the Internet example, a server might transmit a requested code for an application program through the Internet, the ISP, the local network and the network interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
obtaining performance metrics of instances of classifications performed by a classification model in classifying data samples, wherein the classification model is trained to classify the data samples as belonging to a class;
generating a confusion matrix for the classification model, wherein the confusion matrix comprises the instances clustered into a plurality of groups, the plurality of groups comprising a true positive group, a false positive group, a true negative group, and a false negative group;
for each group of the plurality of groups, deriving a threshold from the performance metrics for instances of data samples constituting the respective group;
predicting a classification for an input data sample by applying the input data sample to the classification model;
determining whether or not the predicted classification is correct based on a prediction performance metric of the predicted classification and one or more of the thresholds for the plurality of groups of the confusion matrix; and
updating the predicted classification based on determining whether or not the predicted classification is correct or not.

2. The method of claim 1, wherein the performance metrics comprise a confidence score of the instances.

3. The method of claim 1, wherein the prediction performance metric comprises a confidence score of the predicted classification.

4. The method of claim 1, further comprising:
for each group of the confusion matrix,
clustering the instances into the plurality of groups based on the performance metrics; and
deriving one or more centroids from feature sets of the instances of the data samples constituting the respective group,
wherein determining whether or not the predicted classification is correct is based on the one or more centroids.

5. The method of claim 4, further comprising:
for each group of the plurality of groups, computing a threshold distance based on the one or more centroids of an adjacent group of the plurality of groups.

6. The method of claim 5, wherein the threshold distance for each group is based on a distance between the input data sample and the one or more centroids of the adjacent group.

7. The method of claim 5, wherein determining whether or not the predicted classification is correct comprises:
for each group of the plurality of groups, determining a prediction distance from the one or more centroids of a respective group to the input data sample;
comparing the prediction distance of a respective group to the threshold distance of the respective group; and
updating the predicted classification based on the comparison.

8. The method of claim 6, wherein updating the predicted classification based on the comparison comprises:
responsive to a determination that the input data sample exceeds the threshold distance of the true positive group, comparing the input data sample to the threshold distance of the false negative group; and
responsive to a determination that the input data sample satisfies the threshold distance of the false negative group, classifying the input data sample as a belonging to the class.

9. The method of claim 6, wherein updating the predicted classification based on the comparison comprises:
responsive to a determination that the input data sample exceeds the threshold distance of the true positive group, comparing the input data sample to the threshold distance of the false negative group; and
responsive to a determination that the input data sample does not satisfy the threshold distance of the false negative group, comparing the input data sample to the threshold distance of the true negative group; and
reclassifying the input data sample as a belonging to another class based on the comparison.

10. A system, comprising:
a memory storing instructions; and
at least one processor communicatively connected to the memory and configured to execute the instructions to:
obtain performance metrics of instances of classifications performed by a classification model in classifying data samples, wherein the classification model is trained to classify the data samples as belonging to a class;
generate a confusion matrix for the classification model, wherein the confusion matrix comprises the instances clustered into a plurality of groups, the plurality of groups comprising a true positive group, a false positive group, a true negative group, and a false negative group;
for each group of the plurality of groups, derive a threshold from the performance metrics for instances of data samples constituting the respective group;
predict a classification for an input data sample by applying the input data sample to the classification model;
predict a classification for an input data sample by applying the input data sample to the classification model; and
update the predicted classification based on determining whether or not the predicted classification is correct or not.

11. The system of claim 10, wherein the processor is further configured to execute the instructions to:
for each group of the confusion matrix,
cluster the instances into the plurality of groups based on the performance metrics; and
derive one or more centroids from feature sets of the classification instances of the data samples constituting the respective group,
wherein determining whether or not the predicted classification is correct is based on the one or more centroids.

12. The system of claim 11, wherein the processor is further configured to execute the instructions to:
for each group of the plurality of groups, compute a threshold distance based on the one or more centroids of an adjacent group of the plurality of groups.

13. The system of claim 12, wherein the threshold distance for each group is based on a distance between the input data sample and the one or more centroids of the adjacent group.

14. The system of claim 12, wherein determining whether or not the predicted classification is correct comprises:
for each group of the plurality of groups, determining prediction distance from the one or more centroids of a respective group to the input data sample;
comparing the prediction distance of a respective group to the threshold distance of the respective group; and
updating the predicted classification based on the comparison.

15. The system of claim 12, wherein updating the predicted classification based on the comparison comprises:
responsive to a determination that the input data sample exceeds the threshold distance of the true positive group, comparing the input data sample to the threshold distance of the false negative group; and
responsive to a determination that the input data sample satisfies the threshold distance of the false negative group, classifying the input data sample as a belonging to the class.

16. The system of claim 12, wherein updating the predicted classification based on the comparison comprises:
responsive to a determination that the input data sample exceeds the threshold distance of the true positive group, comparing the input data sample to the threshold distance of the false negative group; and
responsive to a determination that the input data sample does not satisfy the threshold distance of the false negative group, comparing the input data sample to the threshold distance of the true negative group; and
reclassifying the input data sample as a belonging to another class based on the comparison.

17. A non-transitory computer-readable storage medium storing instructions that, when executed by a processor, cause the processor to:
extract metadata associated with instances of classifying data by a machine learning model trained to classify data as belonging to a class, the metadata comprising confidence score and a tag indicative of a correctness for each instance;
cluster the instances into a plurality of groups based on the tags;
derive a plurality of thresholds for each group of the plurality of groups based on confidence scores associated with instances clustered into a respective group;
evaluate a predicted classification, by the machine learning model, for an input data sample based on a comparison of confidence score for the predicted classification to one or more of the plurality of thresholds; and
generate a label for the input data sample based on the evaluation, wherein the label is indicative of whether or not the input data sample belongs to the class.

18. The non-transitory computer-readable storage medium of claim 17, wherein the instructions, when executed by the processor, further cause the processor to:
determine a first plurality of thresholds of the plurality of thresholds from the confidence scores associated with instances clustered into the plurality of groups;
compute one or more centroids for each group of the plurality of groups based on features sets for the instances constituting a respective group;
for each group of the plurality of groups,
determine a second threshold of the plurality of thresholds based on distances from the input data sample to the one or more centroids of another group of the plurality of groups; and
determine a prediction distance from a set of features of the input data sample to the one or more centroids of the respective group,
wherein evaluating the predicted classification comprises one or more of comparing the confidence score for the predicted classification to one or more of the first plurality of thresholds and comparing the prediction distance of a respective group to the second threshold of the respective group.

19. The non-transitory computer-readable storage medium of claim 17, wherein the confidence score comprise a probability that data of an instance corresponds to the class.

20. The non-transitory computer-readable storage medium of claim 17, wherein the confidence score for each instance are determined during a training phase of the machine learning model.
